(19) United States
(12) Patent Application Publication
(10) Pub. No.: US 2015/0111188 A1
(43) Pub. Date: Apr. 23, 2015

(54) Query Response System for Medical Device Recipients

(71) Applicant: Saji Maruthurkkara, Girraween (AU)

(72) Inventor: Saji Maruthurkkara, Girraween (AU)

(21) Appl. No.: 14/061,455

(22) Filed: Oct. 23, 2013

(51) Int. Cl. G09B 5/00; G09B 23/28

(52) U.S. Cl. CPC G09B 5/00; G09B 23/28
USPC 434/262

(57) ABSTRACT

A method and system for responding to queries from medical device recipients. A computing system receives a query from a medical device recipient and determines based on a subject matter of the query a set of relevant recipient attributes. The computing system then refers to profile data for the enquiring recipient to determine relevant attribute values for the determined relevant attributes. The computing system may then find one or more other medical device recipients who have most closely matching attribute values and forwards the query to the identified medical device recipient(s) to solicit a response for transmission to the enquiring recipient. Further, the computing system may maintain a knowledgebase of queries, responses, and linking attribute values, and the computing system may through the knowledgebase based on the determined relevant attribute values to identify relevant knowledgebase records and return to the enquiring recipient an indication of the identified knowledgebase records.

### BACKGROUND

Unless otherwise indicated herein, the information described in this section is not prior art to the claims and is not admitted to be prior art by inclusion in this section.

Individuals who suffer from certain medical conditions may benefit from the use of a medical device. Depending on the type and severity of the medical condition, for instance, an individual may benefit from use of an implanted medical device, which may be either partially implanted or totally implanted. A partially implanted medical device typically includes an external unit that performs at least some processing functions and an implanted unit that delivers a stimulus to a body part of the recipient, such as an organ. A totally implanted medical device, on the other hand, is fully implanted within the body of the recipient. In either case, the medical device may also be configured to communicate with a remote/adjunct device that allows an individual to monitor and adjust various components or functions of the device.

Without limitation, an example of such a medical device is a hearing prosthesis, which may help individuals with various types of hearing loss to perceive sound. For instance, individuals with certain types of conductive hearing loss may benefit from hearing prostheses such a hearing aids and/or vibration-based hearing devices (e.g., middle-ear implants and/or bone-anchored hearing aids). And individuals with certain types of sensorineural hearing loss may benefit from hearing prostheses such as cochlear implants and/or auditory brainstem implants.

An individual who is a candidate for receipt and use of a medical device is referred to herein as a candidate recipient or candidate medical device recipient, whereas an individual who has received and used or uses a medical device is referred to herein as an actual recipient or actual medical device recipient.

### SUMMARY

Medical device recipients, including both candidate recipients and actual recipients, generally need high quality, relevant advice to help manage their expectations regarding the outcome of medical device use, and to help maximize beneficial outcome of their medical device use. Traditionally, medical device recipients have received such advice during consultation with medical device professionals, such as a physicians and clinicians, who draw upon their professional expertise and experience, including their past experience with other recipients and medical devices. Unfortunately, however, a medical device professional's time and experience is limited. Consequently, an improvement is desired.

Disclosed herein are methods and corresponding systems to facilitate providing medical device recipients with useful guidance in a manner that may help to manage their expectations and improve their outcomes, or at least to provide a useful alternative means for such recipients to conveniently obtain high quality, relevant advice.

In accordance with the disclosure, a computer system may store respectively for each of a plurality of recipients a profile record specifying various attribute values for the recipient, such as data related to the recipient's medical condition, the recipient's medical device use and performance, the recipient's age, and so forth. The computer system may then receive from an enquiring recipient a query seeking advice related to a medical device, such as advice related to medical device use and performance, for instance. And in response, the computer system may then (i) determine a set of attributes relevant to the subject matter of the query, (ii) determine from the enquiring recipient's profile record a set of attribute values for the determined set of attributes, (iii) search through the profile records of other recipients to identify at least one target recipient having a profile record that specifies attribute values most closely matching those determined for the enquiring recipient (referred to herein as “linking attribute values”), and (iv) forward the query from the computing system to each of the at least one identified the target recipient to solicit one or more responses to the query.

Optimally in this process, the computer system may maintain in confidence the actual identity of the enquiring recipient and thus not disclose the enquiring recipient's actual identity (e.g., name) to the target recipient. Furthermore, the computing system may then receive from each identified target recipient a response to the query and may forward the response to the enquiring recipient, optimally maintaining in confidence the actual identity of the target (responding) recipient and thus not disclosing the target recipient's actual identity (e.g., name) to the enquiring recipient. In this manner, the enquiring recipient may securely and anonymously receive relevant information from one or more similarly situated recipients.

Furthermore, the computer system may also be configured to maintain a knowledgebase of queries and responses exchanged between medical device recipients, such as queries and responses exchanged in the manner described above for instance, and to key each query-response pair to the linking attribute values. For instance, each time the computer system forwards a query from an enquiring recipient to a target recipient and forwards a response from that target recipient to the enquiring recipient, the computer system may store in the knowledgebase a database record specifying the query and response and the linking attribute values for that query-response pair.

Advantageously, the computer system may then use that knowledgebase to facilitate responding to new queries without the need to forward the queries to target recipients. For instance, when the computer system then receives from an enquiring recipient a query seeking advice related to a medical device, the computer system may (i) determine a set of attributes relevant to a subject matter of the query, (ii) determine from the enquiring recipient's profile record a set of attribute values for the determined set of attributes, (iii) search through the knowledgebase to identify one or more knowledgebase records specifying linking attribute values most closely matching the determined set of attribute values and having a query subject matter most closely matching the subject matter of the enquiring recipient's query, (iv) extract from the identified knowledgebase records information responsive to the query, (v) generate a response to the query based on the extracted information, and (vi) output the generated response for transmission to the enquiring recipient.

In practice with this arrangement, the computer system may provide responses of varying specificity. For example, the computer system may extract from the one or more identified knowledgebase records the full responses provided by target recipients, and the computer system may generate as its response to the enquiring recipient a listing of those extracted responses. The enquiring recipient may then conveniently browse through that list of responses to learn how similarly situated recipients responded to a query of similar subject matter. And as another example, the computer system may roll up or summarize the response data provided in the one or more identified knowledgebase records to establish a representative response metric such as average or the like, and the computer system may include in its response to the enquiring recipient an indication of that representative response metric. Moreover, the computer system may roll up or summarize linking attribute values from the one or more identified knowledgebase records to establish a representative attribute value metric such an average or the like, and the computer system may include in its response to the enquiring recipient an indication of that representative attribute value metric.

As with the embodiment discussed above, the computer system may also maintain in confidence the actual identities of other recipients in this knowledgebase implementation, thus not disclosing to the enquiring recipient the actual identities (e.g., names) of the recipients whose queries and responses were the subject of the one or more identified knowledgebase records. To the extent the computer system provides the enquiring recipient with an indication of linking attributes from the one or more identified knowledgebase records, such information may also not actually identify the other recipients but may provide useful information about their medical device use, performance, and so forth, which may help to provide context for the query responses.

Accordingly, in one respect, disclosed herein is a method that may be implemented by a computer system such as a central computer and/or one or more computers located at one or more medical clinics. The method involves receiving into the computing system a query from an enquiring recipient of a medical device. Further, the method involves the computing system responding to the query by (i) determining a set of one or more attributes corresponding with a subject matter of the query, and (ii) consulting a profile record of the enquiring recipient to determine, for the determined set of one or more attributes, a corresponding set of one or more attribute values for the enquiring recipient. In turn, the method then involves the computing system searching through profile records of other medical device recipients to find a matching profile record specifying one or more attribute values most closely matching the determined set of one or more attribute values for the enquiring recipient, and thereby identifying a target recipient having that matching profile record. And the method then involves, responsive to identifying the target recipient, forwarding the query from the computing system to the identified target recipient to solicit a response to the query.

In practice, the computing system may further identify more than one target recipient, by finding more than one profile record that specifies one or more attribute values most closely matching the determined set of one or more attribute values for the enquiring recipient. For instance, the computing system may identify two or more most closely matching profile records and may thus identify two or more target recipients, such as by rank ordering profile records from most closely matching to least closely matching and selecting the top ranked profile records.

In another respect, disclosed herein is an implementation of the method involving use of a knowledgebase as discussed above. In particular, the method involves a computing system a knowledgebase containing a plurality of records each specifying a query submitted by a respective first medical device recipient and specifying a response to the query provided by a respective second medical device recipient, with each record also specifying a set of one or more linking attribute values for the respective first and second medical device recipients. The method then involves the computing system receiving a query from an enquiring medical device recipient, and the computing system responding to receiving the query by (i) determining a set of one or more attributes corresponding with a subject matter of the received query, and (ii) consulting a profile record of the enquiring medical device recipient to determine, for the determined set of one or more attributes, a corresponding set of one or more attribute values for the enquiring medical device recipient.

In turn, the method then involves the computing system searching through the knowledgebase to identify one or more records of the plurality whose set of one or more linking attribute values most closely match the determined set of one or more attribute values for the enquiring medical device recipient and whose query has a subject matter most closely matching a subject matter of the query received from the enquiring recipient. And the method involves outputting from the computing system in response to the received query an indication of the one or more identified records. For instance, the output may include the query response from each identified record, a representative response metric established based on the one or more identified records, and/or a representative attribute value metric established based on the one or more identified records.

Still further, disclosed herein is a computing system operable to implement a method such as discussed above. Such a computing system may include a network communication interface, one or more processing units, and data storage. Further, the data storage may store profile-record data that includes a plurality of profile records for medical device recipients, each profile record being for a respective medical device recipient and specifying a set of one or more attribute values for the respective medical device recipient. And the data storage may store correlation data that correlates each of various query subject matter categories with a set of one or more medical device recipient attributes.

The data storage may then further store program instructions executable by the one or more processing units to cause the computing system to carry out various functions such as those discussed above. For example, the functions may include receiving via the network communication interface a query from an enquiring medical device recipient. Further, the functions may include, responsive to receiving the query, (i) determining a subject matter category of the received query, (ii) referring to the correlation data to determine for the determined subject matter category a corresponding set of one or more medical device recipient attributes, (iii) looking up a profile record of the enquiring medical device recipient in the profile-record data and determining from the profile record of the enquiring medical device recipient, for the determined set of one or more attributes, a set of one or more attribute values for the enquiring medical device recipient.

The functions may then include searching through the profile-record data to find a matching profile record specifying one or more attribute values most closely matching the determined set of one or more attribute values for the enquiring medical device recipient, and thereby identifying a target medical device recipient having the matching profile record. Moreover, the functions may include outputting the received query for transmission to the identified target medical device recipient, to solicit a response to the received query.

These as well as other aspects, advantages, and alternatives will become apparent to those of ordinary skill in the art by reading the following detailed description, with reference where appropriate to the accompanying drawings. Further, it should be understood that the description throughout by this document, including in this summary section, is provided by way of example only and therefore should not be viewed as limiting.

### BRIEF DESCRIPTION OF THE DRAWINGS

FIG. 1 is a simplified block diagram depicting an example computing system arranged to communicate with a plurality of medical device recipients.

FIG. 2 is a simplified block diagram depicting example sources of recipient profile data.

FIG. 3 is a simplified block diagram depicting an example interrelationship of entities of FIG. 1.

FIG. 4 is a flow chart depicting example functions of a computing system in accordance with the present disclosure.

FIG. 5 is another flow chart depicting example functions of a computing system in accordance with the present disclosure.

FIG. 6 is a simplified block diagram showing components of an example computing system.

### DETAILED DESCRIPTION

In a representative implementation, the present method will be carried out by a computing system that is arranged to interface directly or indirectly with recipients or with others acting on their behalf, to facilitate receiving and responding to recipient queries in the manner described herein for instance. As such, the computing system may take various forms. By way of example, the computing system may comprise a standalone computer, such as a kiosk, arranged to interface directly with various users or their representatives, and having one or more processing units programmed with application logic to carry out the various functions described. Alternatively, or additionally, the computing system may be network based, including one or more servers arranged to interface through one or more network connections with client devices operated by users or their representatives and similarly including one or more processing units programmed with application logic to carry out the functions described.

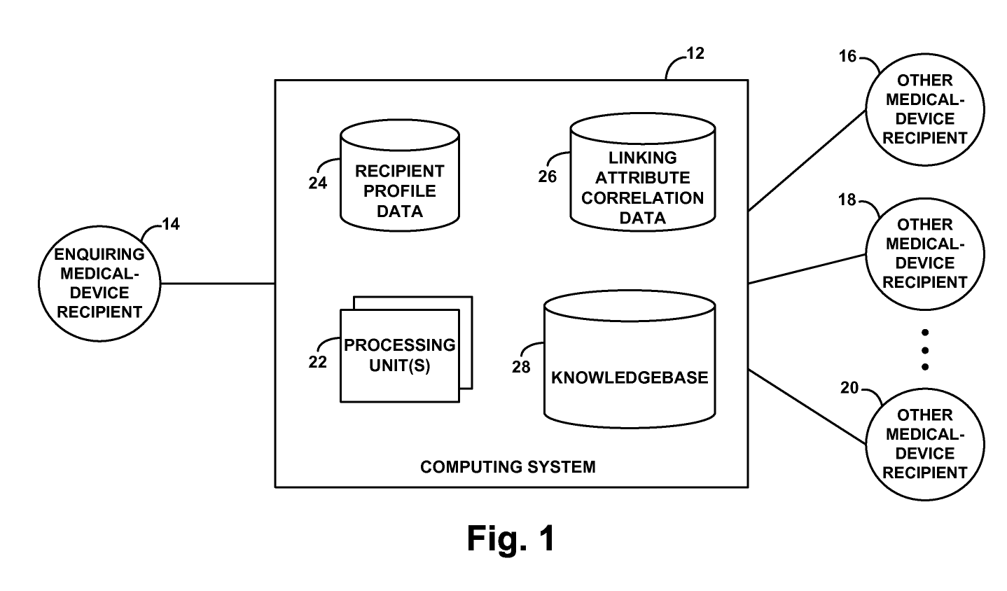

FIG. 1 is a simplified block diagram of an example computing system 12 arranged to communicate with a plurality of medical device recipients (actual recipients and/or candidate recipients) or equivalently with their representatives such as clinicians or family members who may interact with the computing system on their behalf. In particular, the computing system 12 is shown being arranged to communicate with an example enquiring recipient 14 and several other example recipients 16, 18, 20. In practice, each of the illustrated recipients may operate a respective communication device such as a personal computer, mobile phone, or the like, which may be arranged to communicate with the computing system 12 via a network link such as the Internet and to interact with the computing system in accordance with various protocols such as Hypertext Transport Protocol (HTTP), Hypertext Markup Language (HTML), and JAVASCRIPT for instance. Alternatively, the computing system may be arranged to communicate with any of the various recipients in other ways.

The example computing system 12 is shown including one or more representative processing units 22, such as microprocessors, which may be programmed with instructions to carry out various functions described herein. Further, the computing system is shown including various sets of data such as databases, data tables, flat files, or the like, which facilitate various functions described. In particular, the computing system 12 is shown including recipient profile data 24, linking attribute correlation data 26, and a knowledgebase 28.

Although the computing system is shown in a single box for ease of illustration, in practice the computing system may be centralized and/or distributed as suggested above. As such, the illustrated sets of data may all reside in a common computer server or data storage unit or may reside in separate servers or storage units, possibly at separate physical locations, and any of the illustrated data sets may be distributed and replicated to any desired extent. For instance, a portion of a data set may be stored in a centralized server or storage unit, and other portions of the same data set may be stored in various other servers or storage units, possibly as at various medical clinics for instance, with all of the portions being accessible through network or other communication to the extent necessary.

Recipient profile data 24 includes a recipient profile record for each of a plurality of recipients, including a profile record respectively for each of the example recipients shown. Each profile record may take any of a variety of forms, and the profile records may differ in form from each other, although optimally they will have similar enough structure to facilitate efficient searching through the profile records in accordance with the present disclosure. By way of example, each profile record may be a single database record having a plurality of data fields, with each data field having a field name that defines an attribute for the recipient, and each data field holding (or being arranged to hold) a respective value that defines a respective attribute value of that attribute for the recipient. Alternatively, each profile record may be more or less complex than this, possibly including many interrelated database records or other data structures.

As a specific example, in a scenario where each recipient is a hearing prosthesis recipient, each profile record could include various data of the type that might be maintained by a hearing device clinician (e.g., audiologist or physician) for hearing prosthesis recipients, such as recipient name, age, duration of deafness, use of other hearing devices, cause and extent of hearing loss, speech and language development (including whether deafness was pre or post lingual), nature of intervention, habilitation or rehabilitation history, and progress. Further, each profile record could advantageously include still other data related to the hearing prosthesis recipient, such as information about the recipient's prosthesis type, prosthesis age, and prosthesis components, historical records of the recipient's use of the prosthesis, such as frequency of use generally and/or of use of particular prosthesis components, operating modes and settings of the prosthesis and/or its components, battery life data, re-implantation data (including for instance, history of explant, reason for explant), and so forth. Still further, each recipient's profile record optimally specifies a communication address of the recipient, such as an e-mail address, network username, text message address, or the like, to facilitate communication with the recipient.

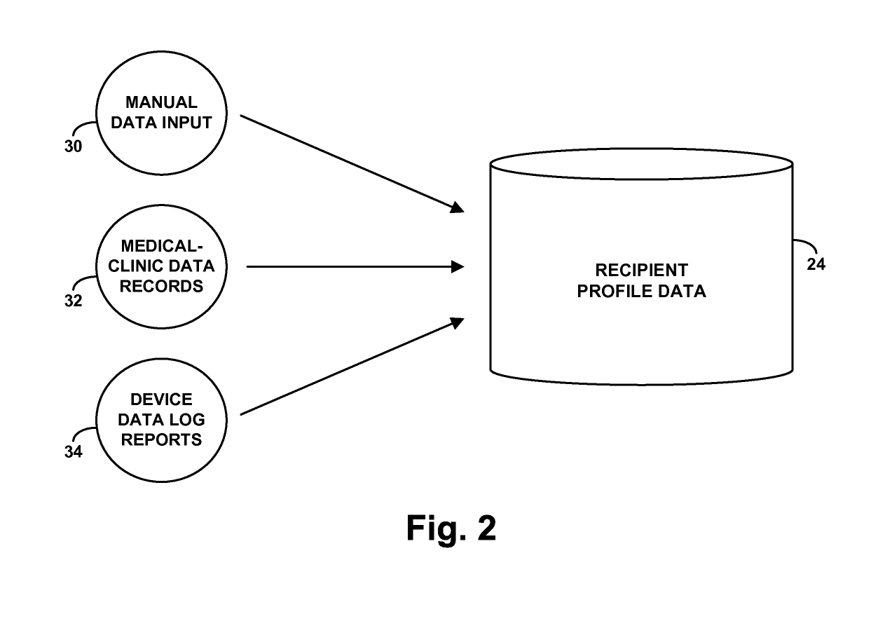

Recipient profile data 24 may be established and updated regularly to reflect ongoing information about each recipient's medical condition and/or medical device use (prospective use and/or actual use) for instance. FIG. 2 helps to illustrate how this could occur in a scenario where the recipient profile data 24 is maintained at a central computer server or perhaps in other arrangements. As shown in FIG. 2, sources of attribute value data for recipient profile records may include manual data entry 30, medical-clinic data records 32, and device data log reports 34, among others.

Initially, for a given recipient, a clinician or other authorized individual may provide manual data entry 30 into a computer interface, such as a web interface to the computing system for instance, to first establish a profile record for the recipient. In response, the computing system may programmatically apply a database template, such as one selected by the clinician and/or appropriate for the medical device or condition at issue, to establish a database record with attribute fields for the recipient, and the computing system may store that database record in profile data 24, populating any attribute fields with attribute values supplied by the clinician. Further, from time to time, the clinician or other authorized individuals may access the profile record to manually add to or otherwise update the attribute values in the recipient's data record, based upon changes in the recipient's medical condition and/or medical device use for instance. Optimally, any such access would comply with applicable requirements to protect privacy of the recipient and the recipient's health information.

As recipients visit and interact with one or more medical clinics, clinicians or others may record data regarding the recipient and/or the recipient's medical device in clinic-maintained databases or the like, such as in local profile records for the recipient. Such medical-clinic data records 32 may then be automatically synchronized from time to time with the recipient profile data 24. For instance, computers at the medical clinics may be programmed to automatically synchronize with the central computer server. Alternatively, such medical-clinic data records may be considered to be part of the recipient profile data without the need for such synchronization.

Device data log reports 34 may be reports of medical device status, operation, and usage history (such as frequency of device usage and/or of device component usage, battery information, and device settings, for instance) and the like. As noted above, some medical devices may be configured to interact with an adjunct/remote device that may facilitate monitoring and/or adjusting the medical device. Such an adjunct/remote device may include a processing unit and data storage and may be configured to log information about the medical device status, operation, usage history, and the like. Further, some medical devices themselves may have their own internal or associated processing units (e.g., sound processors) and data storage units and be similarly configured to log such information. Such an adjunct/remote device and/or medical device may further include a wired and/or wireless communication module through which to transfer the logged data, to the extent authorized and compliant with privacy requirements, to one or more medical clinics and/or to the central server.

Thus, from time to time, a recipient's adjunct/remote device and/or medical device may transfer device data log reports 34 to the computing system to become part of the recipient profile data 24. For example, the device data log reports could be transferred via communication through the recipient's mobile phone, or through an accessory cable and Internet connection, to the computing system, and the computing system may receive those reports and programmatically update the recipient's profile record. And as another example, when the recipient visits a medical clinic, the device data log reports could be transferred through a local wired or wireless connection to a clinic computer for storage in a local profile record of the recipient and/or for subsequent transfer from the clinic computer to the central server.

Still other sources of recipient profile data are possible as well. For example, to the extent the recipient interacts with a web application to evaluate the recipient's medical status, progress, prognosis, medical device usage history, and the like, a server hosting that web application may transfer relevant data regarding the recipient's medical condition and/or medical device for storage as part of the recipient's profile record 24, again to the extent authorized and compliant with applicable privacy requirements. Other examples are possible as well.

Turning back to FIG. 1, linking attribute correlation data 26 or similar data serves a special purpose in the present method, namely, to correlate subject matters or categories of queries with various attributes, so as to enable the computing system to match an enquiring recipient with one or more other recipients and/or with linking attribute values in knowledgebase records.

In practice, each query from an enquiring recipient may have a particular subject matter or subject category. In a scenario where the enquiring recipient submits a query through a web interface or the like, the enquiring recipient may designate the subject matter/category of the query by selecting a subject matter/category from a predefined drop-down list or the like. Alternatively, to the extent the enquiring recipient submits the query as natural language text or the like, the computing system may programmatically discern a subject matter/category of the query by evaluating words and/or phrases of that text, using an automatic subject indexing process that analyzes frequency of word patterns and compares the results with words and phrases of known subject matters/categories for instance.

Optimally, the linking attribute correlation data 26 will correlate or map between each of various query subject matters/categories and a respective set of profile attributes deemed to be relevant to that query subject matter/category. This correlation/mapping, and thus the linking attribute correlation data 26, may be established by design in view of medical professional views of which attributes would be most significant in relation to the query subject matter/category. While greater accuracy and quality of these correlations may facilitate robust operation of the present method, the level of accuracy and quality is not critical to defining the present method and should therefore not be viewed as limiting.

Considering a scenario where each medical device recipient is a cochlear implant or other implanted hearing device recipient, Table 1 is a portion of example of linking attribute correlation data 26. As shown in Table 1, the example linking attribute correlation data 26 specifies four example query categories and correlates with each of these categories with a set of one or more linking attributes. Optimally, the specified linking attributes would correspond with attribute field names in records of the recipient profile data 24, so that, given a query category, the computing system can look up a corresponding (i.e., relevant) set of one or more linking attributes and can then consult recipient profile data 24 to determine one or more attribute values corresponding with the one or more linking attributes.

TABLE 1

| QUERY | |
|---|---|
| CATEGORY | LINKING ATTRIBUTES |
| Performance | Duration of deafness, use of hearing aids, speech and |
| | language development, pre/post lingual deafness |
| Re-implant | History of explant, reason for explant |
| Accessory use | Implant type, implant age, accessory type, accessory use |
| | history |
| Habilitation | Age, pre/post lingual, language |

In the example shown, the “performance” category could be for a query related to how well the recipient should be or will be able to hear when using the implanted hearing device, such as “How will I be able to speak or talk on the phone?” or “Will I have trouble hearing in the presence of noise?” As shown, linking attributes for such queries may be duration of deafness (as a person who had good hearing and received the implant a few months after becoming deaf may perform better than a person who was deaf for twenty years before receiving the implant), use of hearing aids (as a person who used hearing aids before receiving the implant may perform better than a person who did not), speech and language development (as a person who has more advanced speech and language development may perform better than one who does not), and pre/post lingual deafness (as a person who lost their hearing after having developed their speech skills may perform better than a person who lost their hearing before having developed their speech skills).

The “re-implant” category could then be for a query related to a scenario where a recipient's implant failed and the recipient needs a new implant, and where the recipient is concerned about whether the new implant will work, whether the new implant will work as well as the old one, and whether any complications will arise. For such issues, as shown, the relevant linking attributes may be history of explant (such as when the implant was removed and data regarding the removal process and result), and reason for explant (such as that the old implant stopped working, or that the old implant was working but the recipient's hearing ability stopped).

The “accessory use” category could then be for a query related to use of hearing device implant accessories (or components), such as a sound processor, a telecoil, an accessory cable, a remote control, and/or various other accessories, including queries such as “Will there be any issues with so and so accessory?” and the like. As shown, the relevant linking attributes for this category may be the type of implant (as accessory use may differ from implant to implant), the implant age (as accessory use may vary based on implant age), accessory type (as accessory use may differ for different types of accessories), and history of accessory use (as people who use the accessory to a similar extent may have similar experiences and views regarding the accessory).

The “habilitation” category could then be for a query related to habilitation (namely, the process of improving hearing without having had good hearing in the past, contrasted with rehabilitation, which involves working to restore previously good hearing), such as “How should I be training my child to hear so and so sounds?” (Incidentally, this example illustrates how the present disclosure can involve interactions on behalf of recipients, and is thus not limited to interactions with recipients themselves.) As shown, the relevant linking attributes for this category may be the recipient's age, language development, and pre or post lingual deafness.

As noted above, the correlation data in Table 1 is set forth here merely by way of example. In practice, the correlations may take vastly different form and the linking attribute correlation data 26 may address other query subjects/categories and other linking attributes. Thus, the example shown in Table 1 should not be viewed as limiting.

Continuing with reference to FIG. 1, knowledgebase 28 also serves a special purpose for the present method, namely, maintaining a record of query-response pairs and associated linking attribute values as discussed above, to enable the computing system to respond to queries without the need to forward queries to other recipients for response, and to allow enquiring recipients to conveniently browse through previous potentially relevant responses. In practice, each time the computing system receives a query from an enquiring recipient and forwards the query to a target recipient deemed to have attributes values most closely matching those of the enquiring recipient, and the computing system then receives a response from the target recipient and forwards the response to the enquiring recipient, the computing system may store in the knowledgebase a record that specifies the query, a subject matter of the query, the response, and the associated linking attribute values, to facilitate later searching and extraction of useful data from the knowledgebase.

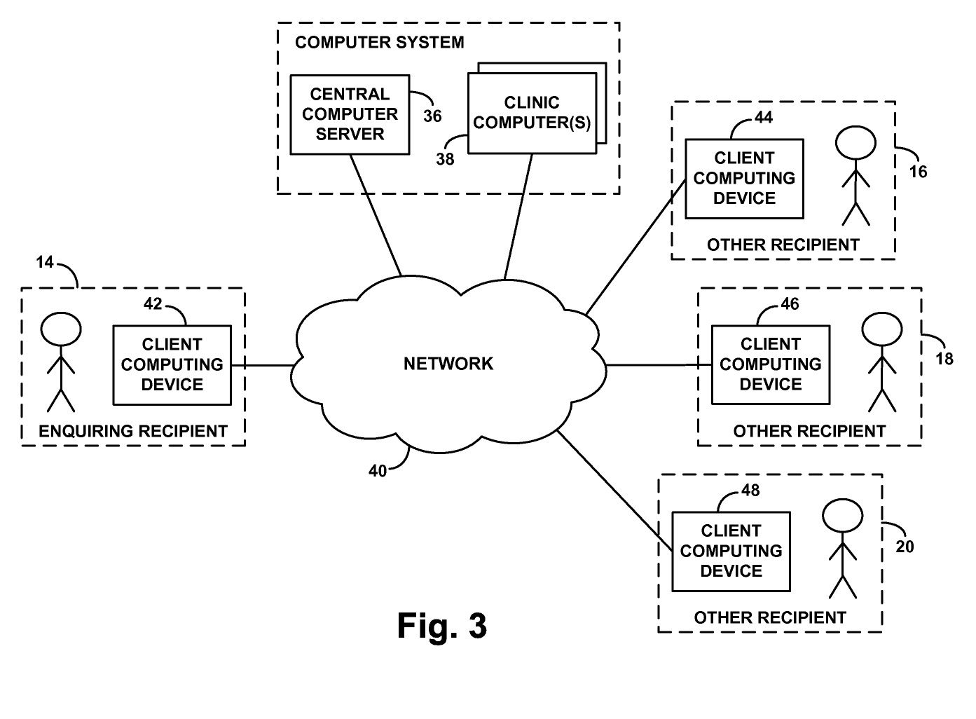

FIG. 3 is next another simplified block diagram depicting the interrelationship of various entities shown in or suggested by FIG. 1, in an arrangement where the entities communicate with each other via a network such as the Internet. As shown in FIG. 3, the computing system 12 is shown including a central computer server 36 and various medical-clinic computers (e.g., servers) 38. These computers are then shown sitting as nodes on a network 40 such as the Internet. In practice, each computers may be coupled with a local area network, which may then provide connectivity with network 40, or the computers may be communicatively linked with the network in some other manner.

Additionally shown with communication links to network 40 are then various client computing devices operable by or for recipients. In particular, continuing with the example shown in FIG. 1, example enquiring recipient 14 is represented as a stick figure operating a respective client computing device 42, and the other example recipients 16, 18, 20 are represented as stick figures operating a respective client computing devices 44, 46, 48. As noted above, the client computing devices may be configured to communicate with the computing system 12 using various protocols. In practice, any such device may also be programmed with application logic to conveniently facilitate user interaction with the computing system, such as submission of queries and response to queries.

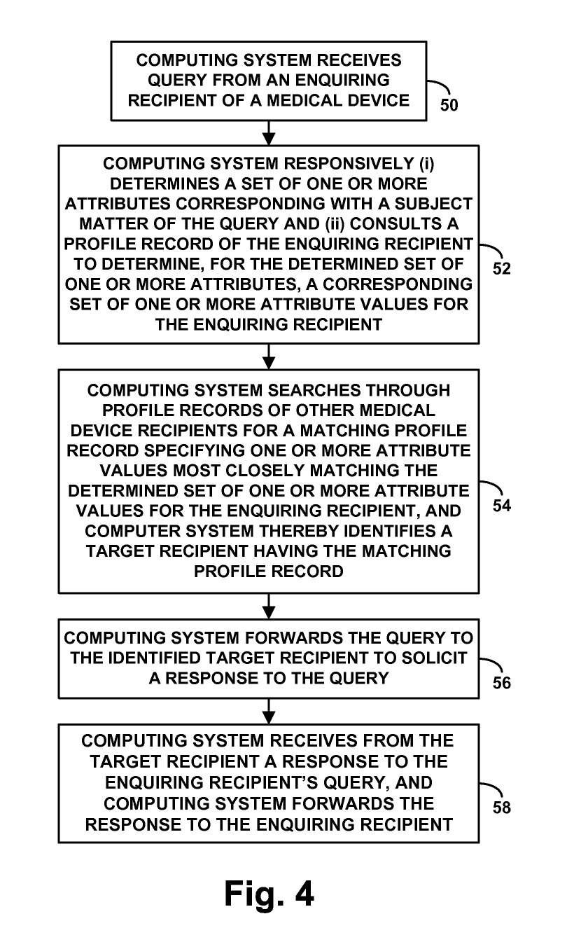

Turning next to FIG. 4, a flow chart is provided to help illustrate functions that can be carried out by computing system 12 in an example implementation of the present method. In practice, one or more processing units of the computing system may be programmed with instructions executable to carry out these functions, in an arrangement such as that described above.

As shown in FIG. 4, at block 50, the computing system receives a query from an enquiring recipient of a medical device. In the arrangement of FIGS. 1 and 2, for instance, this may involve enquiring recipient 14 entering into a user interface provided at client computing device 42 a query related in some manner to the enquiring recipient's medical condition and/or medical device. In practice, for example, the user interface may be a web page interface or other interface that provides the enquiring recipient with spaces in which to select and thus designate a query category and/or to enter text of the query. Alternatively, other query entry means could be used. Upon clicking submit or as the user enters the query, client computing device 42 may then transmit the entered query (e.g., designated category and query text) to the computing system, to facilitate receipt by the computing system. Further, as noted above, recipient interactions with the system could be done on behalf of the recipient. Thus, the act of the computing system receiving the query from the enquiring recipient could involve the computing system receiving the query entered on behalf of the recipient, such as by a clinician, parent, or other individual.

Optimally, the query received by the computing system would identify the enquiring recipient, such as by designating a username or other credentials of the enquiring recipient or perhaps simply by originating from the communication address that the recipient profile data 24 specifies for the enquiring recipient. This identification of the enquiring recipient will enable the computing system to refer to the enquiring recipient's profile record in the recipient profile data and to associate the received query with the enquiring recipient.

At block 52, in response to receiving the query, the computing system (i) determines a set of one or more attributes corresponding with a subject matter of the query, and (ii) consults a profile record of the enquiring recipient to determine, for the determined set of one or more attributes, a corresponding set of one or more attribute values for the enquiring recipient.

In practice, the computing system may determine the set of one or more attributes corresponding with a subject matter of the query by first determining a subject matter of the query in line with the discussion above, and then looking up the determined query subject matter in the linking attribute correlation data 26 to determine one or more attributes that the correlation data correlates with the determined query subject matter. For example, the computing system may read a query subject matter specified by the enquiring recipient and thus included with the received query and/or may evaluate text of the received query to determine a query subject matter (e.g., by identifying one or more keywords in the query and determining the query subject matter based on the identified one or more keywords), and the computing system may then look up that determined query subject matter in the linking attribute correlation data 26 to determine the associated linking attributes.

Given a query such as “Will I have trouble hearing in the presence of noise?”, for instance, the computing system may determine that the subject matter of the query is performance, and the computing system may then determine from correlation data 26 that the associated linking attributes are duration of deafness, use of hearing aids, speech and language development, and pre/post lingual deafness as shown in Table 1 and discussed above.

The computing system may then consult the enquiring recipient's profile record to determine a set of one or more attribute values corresponding with the determined set of one or more attributes. In particular, the computing system may look up the enquiring recipient's profile record in the recipient profile data 24 based on the identity of the enquiring recipient and, for each attribute of the determined set of one or more attributes, may read the corresponding attribute value if any that the recipient's profile record specifies. This determined set of one or more attribute values for the enquiring recipient may include clinical data of the enquiring recipient (e.g., medical condition status, performance, and/or prognosis) and/or performance history of the enquiring recipient's medical device (e.g., frequency of use and/or operational state of the medical device and/or of particular components of the medical device).

At block 54, the computing system then searches through profile records of other medical device recipients for a matching profile record specifying one or more attribute values most closely matching the determined set of one or more attribute values for the enquiring recipient, and the computer system thereby identifies a target recipient having the matching profile record.

In practice, for instance, the computing system may conduct a query on the profile records of other recipients in the recipient profile data 24, with the query being keyed to the one or more attribute values determined for the enquiring recipient. This profile record query may search for other profile records that specify the same one or more attribute values and/or that come closest to specifying the same one or more attribute values (e.g., having the greatest number of matching attribute values), and the computing system may select one or more such matching profile records. Further, the profile record query may be based one or more other factors as well, such as how recently the profile record data were updated for instance. For each such matching profile record, the computing system may then deem the recipient having that profile record to be a target recipient.

As a specific example of this process, for each profile record in the recipient profile data 24, the computing system may compare the determined set of one or more attribute values for the enquiring recipient with attribute values (for the same attributes) in the profile record and may assign a similarity-score to the profile record. The computing system may then rank order the profile records in order of their similarity-scores and select one or more top-ranked profile record. Through this or another process, in the event the computing system finds multiple profile records that specify one or more attribute values equally matching the determined set of one or more attribute values for the enquiring recipient, the computing system may select all of those profile records or may select a proper subset of those profile records, randomly or based on one or more factors.

At block 56, in response to identifying the target recipient (or each such target recipient), the computing system then forwards the query to the identified target recipient to solicit a response to the query. To facilitate this, for instance, the computing system may read from the target recipient's profile record a communication address of the target recipient, such as an e-mail address, text message address, or the like, and may then transmit the enquiring recipient's query to that communication address. By way of example, if the enquiring recipient had asked “Will I have trouble hearing in the presence of noise?”, the computing system may transmit to the target recipient a message that reads “Another recipient has asked: ‘Will I have trouble hearing in the presence of noise?’ If you have a response to this query, please reply to this communication with your response.”

Optimally in this process, the computing system may preserve the enquiring recipient's privacy by not disclosing to the target recipient the enquiring recipient's actual identity, such as the enquiring recipient's name or other information that would allow the target recipient to determine who the enquiring recipient is. Further, the computing system may additionally protect the enquiring recipient's privacy by not disclosing to the target recipient the set of one or more attribute values of the enquiring recipient that were used as a basis for identifying the matching target recipient. Thus, even though the determined set of one or more attribute values for the enquiring recipient may include private information of the enquiring recipient (such as clinical data and/or medical device performance data), and even though the computing system may have used that data as a basis for searching through the profile records to thereby identify the target recipient and soliciting a response to the enquiring recipient's query, the computing system may keep the actual identify of the enquiring recipient confidential.

At block 58, the computing system then receives from the target recipient a response to the enquiring recipient's query, and the computing system forwards the response to the enquiring recipient. In practice, for instance, the computing system may receive from the target recipient a response e-mail or text message in the which the target recipient entered a response to the query, and the computing system may then output for transmission to the enquiring recipient that received response, such as in a web page or other response communication. Optimally in this process, the computing system may also protect the privacy of the target recipient by not disclosing to the enquiring recipient the actual identity of the target recipient.

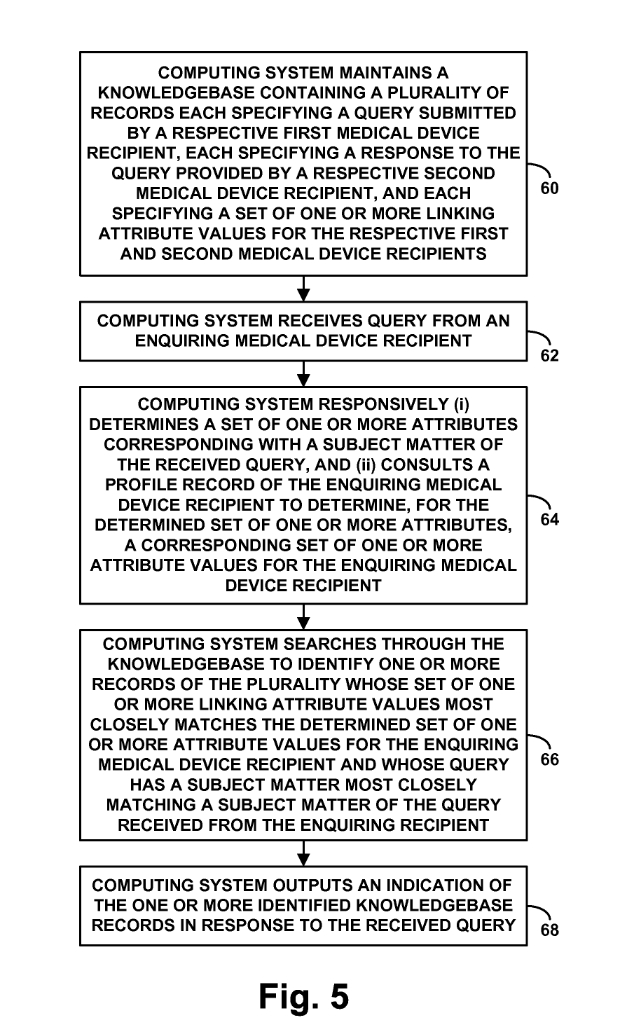

FIG. 5 is next a flow chart illustrating functions that can be carried out by computing system 12 in another example implementation of the present method. Here again, one or more processing units of the computing system may be programmed with instructions executable to carry out these functions, in an arrangement such as that described above.

As shown in FIG. 5, at block 60, the computing system maintains a knowledgebase containing a plurality of records each specifying a query submitted by a respective first medical device recipient and perhaps a subject matter of the query, each specifying a response to the query provided by a respective second medical device recipient, and each specifying a set of one or more linking attribute values for the respective first and second medical device recipients. As discussed above, for instance, the computing system may establish this knowledgebase over time by recording queries, responses, and linking attribute values as the computing system receives queries, determines query subject matters, determines linking attribute values, forwards queries to target recipients, and receives responses from target recipients.

At block 62, which would occur while the computing system is maintaining the knowledgebase, the computing system receives a query from an enquiring medical device recipient. Further, at block 64, in response to receiving the query, the computing system (i) determines a set of one or more attributes corresponding with a subject matter of the received query, and (ii) consults a profile record of the enquiring medical device recipient to determine, for the determined set of one or more attributes, a corresponding set of one or more attribute values for the enquiring medical device recipient. These functions may occur largely in the same manner discussed above for instance.

At block 66, the computing system then searches through the knowledgebase to identify one or more records of the plurality whose set of one or more linking attribute values most closely matches the determined set of one or more attribute values for the enquiring medical device recipient and whose query has a subject matter most closely matching a subject matter of the query received from the enquiring recipient.

In practice, for instance, the computing system may conduct a query on the records in knowledgebase 28, with the query being keyed to the one or more attribute values determined for the enquiring recipient and to the subject matter of the enquiring recipient's query. This knowledgebase query may search for knowledgebase records that specify the same one or more attribute values and same query subject matter and/or that come closest to specifying the same one or more attribute values and same query subject matter (e.g., having the greatest number of matching attribute values and most similar query subject matter), and the computing system may select one or more such matching knowledgebase records. Further, the query may be based one or more other factors as well, such as how recently the knowledgebase record was established for instance.

As a specific example of this process, the computing system may first filter the knowledgebase records to be limited to those having the same query subject matter as the enquiring recipient's query. The computing system may then search through the resulting set of knowledgebase records to find one or more knowledgebase records specifying one or more linking attribute values most closely matching the one or more attribute values determined for the enquiring recipient, in much the same manner as discussed above for finding matching profile records for instance.

At block 68, the computing system then outputs an indication of the one or more identified knowledgebase records in response to the received query. In practice, for instance, the computing system may transmit to the enquiring recipient a web page or other communication that sets forth the response from each of the identified knowledgebase records. For example, if the computing system had identified ten knowledgebase records, the computing system may generate and transmit to the enquiring recipient a web page that lists the responses contained in those ten knowledgebase records, effectively as a knowledgebase search results page through which the enquiring recipient may then conveniently browse the responses. Those responses may be natural language responses, as entered by the target recipients.

Further, rather than or in addition to outputting as the indication of the one or more identified knowledgebase records the responses contained in the one or more identified knowledgebase records, the computing system may establish based on the response data in the identified knowledgebase records one or more representative metrics and may output such representative metric(s) as an indication of the one or more identified knowledgebase records. For instance, to the extent the computing system identified multiple knowledgebase records and those knowledgebase records all include numerical response value responses on a particular topic (e.g., duration of performance or condition), the computing system could average or otherwise roll up those numerical values to establish benchmark data and could provide as a representative metric that benchmark data, possibly incorporating the data in a natural language expression, such as “The typical duration is” so and so.

Still further, the computing system could also or alternatively establish based on the linking attribute data in the one or more identified knowledgebase records one or more representative metrics and may output such representative metric(s) as an indication of the one or more identified knowledgebase records. For instance, to the extent the computing system identified multiple knowledgebase records and those knowledgebase records each included a numerical linking attribute value of battery life and/or device performance duration, the computing system could average or otherwise statistically combine that linking attribute value data from the identified knowledgebase records to establish normative benchmark data, and the computing system could provide that normative data as a representative metric. Other examples are possible as well.

In this process, as with the process discussed above, the computing system may optimally protect the privacy of recipients by excluding certain data from the response to the enquiring medical device recipient. For instance, although the computing system may output in response to the received query information related to one or more responses and/or linking attribute values from the one or more identified knowledgebase records, the computing system may exclude from that output (i) a specification of the determined set of one or more attribute values (ii), for each output record, an actual identification the respective first medical device recipient, and (iii) for each output record, an actual identification of the respective second medical device recipient.

In addition, in line with the discussion above, the computing system may include a central computer remote from a medical clinic and may further include a clinic computer at the medical clinic. In that case, the clinic computer may maintain or have access to at least a portion of the knowledgebase. For instance, as the central computer receives recipient queries and identifies linking attribute values, the central computer may signal to the clinic computer to elicit a search by the clinic computer through recipient profile records for profile records most closely matching the determined linking attribute values, and in this process the central computer may provide the clinic computer with the query, the query subject matter, and the linking attribute values but may exclude private information of the enquiring recipient, such as the actual identity of the enquiring recipient. The clinic computer may then identify target recipients and solicit query responses as discussed above And the clinic computer may store in the knowledgebase a record of the query, the query subject matter, the linking attribute values, and the response.

In practice, the function of block 60 may involve the central computer receiving the query from the enquiring recipient, and the function of block 62 may involve the central computer determining the corresponding set of one or more attribute values. In turn, the method may then involve the central computer transmitting to the clinic computer the received query and the determined set of one or more attribute values but not transmitting to the clinic computer an actual identity of the enquiring recipient. And the function of block 66 may involve the clinic computer searching through at least the portion of the knowledgebase, and the clinic computer may then provide to the central computer a result of the searching done by the clinic computer.

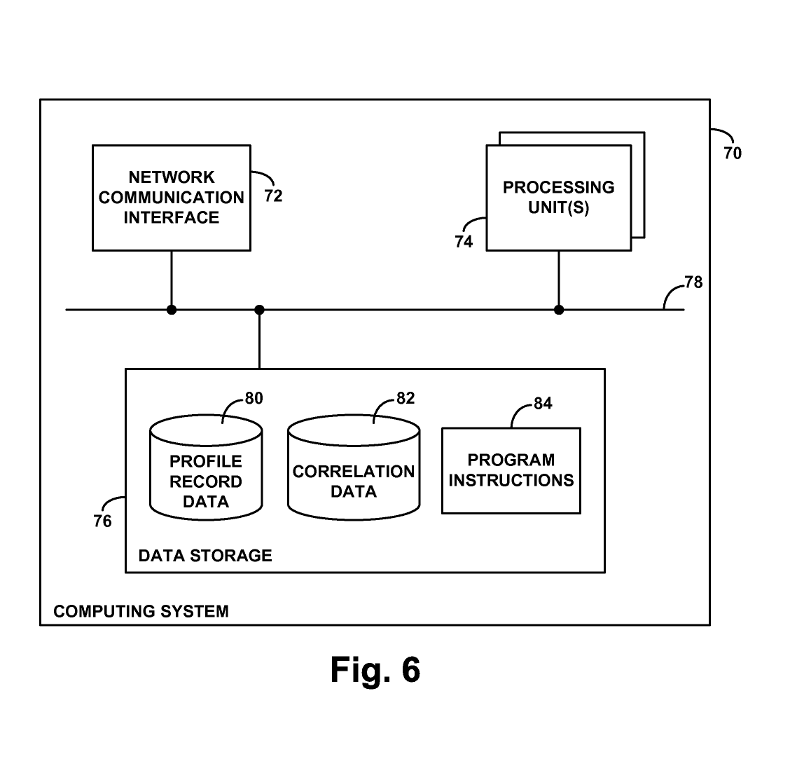

FIG. 6 is next a simplified block diagram depicting components of a representative computing system 70 operable in an arrangement such as that described above. As shown, the computing system 70 includes a network communication interface 72, one or more processing units 74, and data storage 76, all of which may be communicatively linked together by a system bus, network, or other connection mechanism 78.

Network communication interface 72 may comprise one or more Ethernet modules and/or other interface mechanisms enabling the computing system to communicate with various recipient client devices and other network components. Processing unit(s) 74 may then comprise one or more general purpose processors (e.g., microprocessors) and/or one or more special-purpose processors (e.g., application specific integrated circuits). And data storage 76 may comprise one or more volatile and/or non-volatile storage components, such as magnetic, optical, and/or flash memory for instance.

In line with the discussion above, data storage 76 holds profile-record data 80, which includes a plurality of profile records for medical device recipients, each profile record being for a respective medical device recipient and specifying a set of one or more attribute values for the respective medical device recipient. Further, data storage 76 holds correlation data 82, which correlates each of various query subject matter categories with a respective set of one or more medical device recipient attributes.

And data storage 76 then holds program instructions (e.g., machine language instructions) 84, which may be executable by processing unit(s) 74 to cause the computing system 70 to carry out various functions described herein. For example, the functions may include receiving via the network communication interface 72 a query from an enquiring medical device recipient. Further, the functions may include, responsive to receiving the query, (i) determining a subject matter category of the received query, (ii) referring to the correlation data 82 to determine for the determined subject matter category a corresponding set of one or more medical device recipient attributes, and (iii) looking up a profile record of the enquiring medical device recipient in the profile-record data 80 and determining from the profile record of the enquiring medical device recipient, for the determined set of one or more attributes, a set of one or more attribute values for the enquiring medical device recipient.

The functions may then include searching through the profile-record data to find a matching profile record specifying one or more attribute values most closely matching the determined set of one or more attribute values for the enquiring medical device recipient, and thereby identifying a target medical device recipient having the matching profile record. And the functions may include outputting the received query via the network communication interface 72 for transmission to the identified target medical device recipient, to solicit a response to the received query.

Exemplary embodiments have been described above. It should be understood, however, that numerous variations from the embodiments discussed are possible, while remaining within the scope of the invention.

What is claimed is:

1. A method comprising:
receiving into a computing system a query from an enquiring recipient of a medical device;
responsive to receiving the query, (i) determining by the computing system a set of one or more attributes corresponding with a subject matter of the query, and (ii) consulting by the computing system a profile record of the enquiring recipient to determine, for the determined set of one or more attributes, a corresponding set of one or more attribute values for the enquiring recipient;
searching by the computing system, through profile records of other medical device recipients for a matching profile record specifying one or more attribute values most closely matching the determined set of one or more attribute values for the enquiring recipient, and thereby identifying a target recipient having the matching profile record; and
responsive to identifying the target recipient, forwarding the query from the computing system to the identified target recipient to solicit a response to the query.

2. The method of claim 1, wherein the medical device is a hearing device selected from the group consisting of a cochlear implant, a middle-ear implant, a bone anchored hearing aid, and an auditory brainstem implant.

3. The method of claim 1, wherein the enquiring recipient of the medical device is an actual recipient of the medical device or a candidate recipient of the medical device.

4. The method of claim 1, wherein the determined set of one or more attribute values for the enquiring recipient comprises at least one attribute value selected from the group consisting of (i) clinical data of the enquiring recipient and (ii) performance history of the medical device.

5. The method of claim 1, wherein the determined set of one or more attribute values for the enquiring recipient comprises private information of the enquiring recipient, and wherein, although the computing system uses the determined set of one or more attribute values as a basis for the searching through the profile records to thereby identify the target recipient, the computing system does not disclose an actual identity of the enquiring recipient to the identified target recipient.

6. The method of claim 5, further comprising maintaining by the computing system a set of correlation data that correlates each of various query subject matters with a respective set of one or more attributes, including correlating different query subject matters with different sets of one or more attributes,
wherein determining by the computing system the set of one or more attributes corresponding with the subject matter of the received query comprises (i) determining by the computing system the subject matter of the received query and (ii) referring by the computing system to the correlation data to determine the set of one or more attributes that the correlation data correlates with the determined subject matter of the query.

7. The method of claim 6, wherein determining by the computing system the subject matter of the query comprises identifying by the computing system one or more keywords in the query and determining by the computing system the subject matter based on the identified one or more keywords.

8. The method of claim 6, wherein determining by the computing system the subject matter of the query comprises receiving with the query a specification of the subject matter of the query.

9. The method of claim 1, wherein the medical device is a hearing prosthesis implant, and wherein the subject matter of the query comprises a subject matter selected from the group consisting of (i) hearing performance, (ii) hearing prosthesis re-implantation, (iii) hearing prosthesis accessory use, and (iv) hearing habilitation.

10. The method of claim 1, wherein receiving into the computing system the query from the enquiring recipient comprises receiving into the computing system the query entered on behalf of the enquiring recipient.

11. The method of claim 1, further comprising storing by the computing system the profile record of the enquiring recipient and the profile records of the other medical device recipients.

12. The method of claim 11, wherein the storing is at a centralized computer server remote from a plurality of medical clinics, the method further comprises receiving into the centralized computer server, from the plurality of medical clinics, data defining contents of the profile records, and storing the received data in the profile records.

13. The method of claim 11, wherein the profile record of the enquiring recipient comprises multiple profile records of the enquiring recipient stored at multiple locations including at one or more medical clinics.

14. The method of claim 1, wherein the profile record of the enquiring recipient defines a plurality of fields each for a respective attribute and each specifying a corresponding attribute value, and wherein consulting by the computing system the profile record of the enquiring recipient to determine, for the determined set of one or more attributes, a corresponding set of one or more attribute values for the enquiring recipient comprises, for each attribute of the determined set of one or more attributes, looking up in the profile record of the enquiring recipient to determine a corresponding attribute value.

15. The method of claims 1,
wherein the profile record of the enquiring recipient defines a plurality of fields each for a respective attribute and each specifying a corresponding attribute value,
wherein the profile record of each other medical device recipient also defines a plurality of fields each for a respective attribute and each specifying a corresponding attribute value, and
wherein searching by the computing system through the profile records of other medical device recipients for a matching profile record specifying one or more attribute values most closely matching the determined set of one or more attribute values for the enquiring recipient comprises searching through the profile records of the other medical device recipients to find as the matching profile record a profile record having a greatest number of attributes values matching the determined set of one or more attribute values for the enquiring recipient.

16. A method comprising:
maintaining by a computing system a knowledgebase containing a plurality of records each specifying a query submitted by a respective first medical device recipient and specifying a response to the query provided by a respective second medical device recipient, wherein each record further specifies a set of one or more linking attribute values for the respective first and second medical device recipients;
receiving into a computing system a query from an enquiring medical device recipient;
responsive to receiving the query, (i) determining by the computing system a set of one or more attributes corresponding with a subject matter of the received query, and (ii) consulting by the computing system a profile record of the enquiring medical device recipient to determine, for the determined set of one or more attributes, a corresponding set of one or more attribute values for the enquiring medical device recipient;
searching by the computing system through the knowledgebase to identify one or more records of the plurality whose set of one or more linking attribute values most closely matches the determined set of one or more attribute values for the enquiring medical device recipient and whose query has a subject matter most closely matching a subject matter of the query received from the enquiring recipient; and
outputting from the computing system in response to the received query an indication of the one or more identified records.

17. The method of claim 16, wherein the enquiring recipient of the medical device is an actual recipient of the medical device or a candidate recipient of the medical device.

18. The method of claim 16, wherein the set of one or more attribute values comprises at least one attribute value selected from the group consisting of (i) clinical data and (ii) medical device performance history.

19. The method of claim 16, wherein further comprising excluding from output (i) the determined set of one or more attribute values (ii), for each output record, an actual identification the respective first medical device recipient, and (iii) for each output record, an actual identification of the respective second medical device recipient.

20. The method of claim 16, further comprising:
establishing by the computing system, for the one or more identified records, a representative metric of response data in the one or more identified records,
wherein outputting the indication of the one or more identified records comprises including in the output indication an indication of the established representative metric.

21. The method of claim 16, further comprising:
establishing by the computing system, for the one or more identified records, a representative metric of one or more linking attribute values in the one or more identified records,
wherein outputting the indication of the one or more identified records comprises including in the output indication an indication of the established representative metric.

22. The method of claim 16, wherein the one or more identified records is a plurality of identified records, the method further comprising generating the indication at least in part by rolling up data from the plurality of records so as to establish benchmark data as at least part of the indication.

23. The method of claim 22, wherein rolling up data from the plurality of records so as to establish the benchmark data comprises:
reading the plurality of records to determine response data from the plurality of records; and
averaging the determined response data to establish, as at least part of the benchmark data, an average the determined response data.

24. The method of claim 22, wherein rolling up data from the plurality of records so as to establish the benchmark data comprises:
reading the plurality of records to determine linking attribute values from the plurality of records; and
averaging the determined linking attribute values to establish, as at least part of the benchmark data, an average of the determined linking attribute values.

25. The method of claim 16, wherein the output response comprises a natural language response.

26. The method of claim 16,
wherein the computing system comprises a central computer remotely from a medical clinic and further comprises a clinic computer at the medical clinic, wherein the clinic computer maintains or has access to at least a portion of the knowledgebase,
wherein receiving the query from the enquiring recipient comprises receiving the query into the central computer,
wherein consulting to determine the corresponding set of one or more attribute values is done by the central computer,
the method further comprising the central computer transmitting to the clinic computer the received query and the determined set of one or more attribute values but not transmitting to the clinic computer an actual identity of the enquiring recipient, and
wherein searching through the knowledgebase comprises the clinic computer searching through at least the portion of the knowledgebase, the method further comprising the clinic computer providing to the central computer a result of the searching by the clinic computer.

27. A computing system comprising:
a network communication interface;
one or more processing units;
data storage;
profile-record data stored in the data storage, wherein the profile-record data includes a plurality of profile records for medical device recipients, each profile record being for a respective medical device recipient and specifying a set of one or more attribute values for the respective medical device recipient;
correlation data stored in the data storage, wherein the correlation data correlates each of various query subject matter categories with a respective set of one or more medical device recipient attributes; and
program instructions stored in the data storage and executable by the one or more processing units to cause the computing system to carry out functions comprising:
(a) receiving via the network communication interface a query from an enquiring medical device recipient,
(b) responsive to receiving the query, (i) determining a subject matter category of the received query, (ii) referring to the correlation data to determine for the determined subject matter category a corresponding set of one or more medical device recipient attributes, and (iii) looking up a profile record of the enquiring medical device recipient in the profile-record data and determining from the profile record of the enquiring medical device recipient, for the determined set of one or more attributes, a set of one or more attribute values for the enquiring medical device recipient,
(c) searching through the profile-record data to find a matching profile record specifying one or more attribute values most closely matching the determined set of one or more attribute values for the enquiring medical device recipient, and thereby identifying a target medical device recipient having the matching profile record, and
(d) outputting the received query via the network communication interface for transmission to the identified target medical device recipient, to solicit a response to the received query.

28. The computing system of claim 27, wherein the enquiring recipient of the medical device is an actual recipient of the medical device or a candidate recipient of the medical device.

29. The computing system of claim 27, wherein the functions further comprise receiving from the identified target medical device recipient a response to the received query, and outputting the received response for transmission via the network communication interface to the enquiring medical device recipient.

30. The computing system of claim 27, wherein the determined set of one or more attribute values for the enquiring medical device recipient comprises private information of the enquiring medical device recipient, and wherein, although the computing system uses the determined set of one or more attribute values as a basis for the searching through the profile-record data to thereby identify the target medical device recipient, the computing system does not disclose an identity of the enquiring medical device recipient to the identified target medical device recipient.
